(19) United States
(12) Patent Application Publication
(10) Pub. No.: US 2008/0282068 A1
(43) Pub. Date: Nov. 13, 2008

(54) HOST COMMAND EXECUTION ACCELERATION METHOD AND SYSTEM

(75) Inventors: Chin-sung Lee, Hsinchu County (TW); Chih-yung Cheng, Taipei City (TW); Hong-ching Chen, Kao-Hsiun Hsien (TW)

Correspondence Address: MADSON & AUSTIN, 15 WEST SOUTH TEMPLE, SUITE 900, SALT LAKE CITY, UT, 84101, US

(73) Assignee: MEDIATEK Inc., Hsin-Chu (TW)

(21) Appl. No.: 11/776,895

(22) Filed: Jul. 12, 2007

Related U.S. Application Data
(60) Provisional application No. 60/916,713, filed on May 8, 2007.

(51) Int. Cl. G06F 7/38

(52) U.S. Cl. 712/220

(57) ABSTRACT

The present invention sets forth an interface method and system for host acceleration between an electronic device and a host PC. The system comprises an acceleration unit for rapidly classifying a type of an host command then issuing a flag signal to a microprocessor. The microprocessor then executes corresponding actions according to the flag signal and the host command without parsing the host command for accelerating the data communication between the device and a host PC.

### CROSS-REFERENCE TO RELATED APPLICATION

The present application claims priority of Provisional Application No. 60/916,713, entitled “METHOD FOR HARDWARE ACCELERATION IN ATAPI INTERFACE”, filed on May 8, 2007, which is hereby incorporated by reference.

### FIELD OF THE INVENTION

The present invention generally relates to a method and a system for command execution acceleration.

### BACKGROUND OF THE INVENTION

In the basic operation between an optical disk drive and a host PC (Personal Computer), the host PC issues an ATAPI (Advanced Technology Attachment Packet Interface) command to the optical disk drive through an ATAPI interface to request or access data. The optical disk drive parses the ATAPI command after receives it, and classifies the type of the ATAPI command in order to execute corresponding actions. A standard operation to handle the ATAPI command can be divided into four general phases as shown in FIG. 1:
Phase 1: The host PC issues an ATAPI command and a system (which can be implemented by firmware) of the optical disk drive receives the ATAPI command.
Phase 2: The system parses the ATAPI command and classifies the type thereof, then makes the optical disk drive operate according to the ATAPI command.
Phase 3: The system executes corresponding actions such as data communication between the host PC and the optical disk drive under a PIO (Programmed Input/Output) or UDMA (Ultra Direct Memory Access) mode.
Phase 4: When the data communication between the host PC and the optical disk drive is accomplished, the optical disk drive reports a data-communication-accomplished signal to the host PC. The host PC is ready to issue the next ATAPI command after the host PC has received the data-communication-accomplished signal.

A transfer rate is used for evaluating the data communication performance between the host PC and the optical disk drive, the transfer rate is represented as:

$$Transfer Rate = \frac{Transferred Data Bytes}{Time}$$

wherein the transferred data bytes represent the total sectors being transferred, and the time represents total duration from phase 1 to phase 4.

It is apparent that the transfer rate can be improved by reducing total duration from phase 1 to phase 4. Therefore, in order to improve the transfer rate, there is a need to provide a way of reducing total duration of the data communication between the host PC and the optical disk drive.

### SUMMARY OF THE INVENTION

The method of present invention comprises following steps of: Step 1 Determining whether the host command fits to an accelerating criteria.
Step 2 Generating a criteria hit flag signal if the host command fits to the accelerating criteria.
Step 3 Executing corresponding actions of the host command if the criteria hit flag signal is issued.

The criteria is selected from (a). the command is an access command to access a storage medium;(b). the data to be access is continues to previous accessed data; and (c). a buffer memory is ready for executing the host command.

The method of present invention could be implemented in the system comprises an interface unit, an acceleration unit, a memory, a buffer memory, and a microprocessor. The interface unit handles the data communication between the electronic device and a host PC. A host command issued from the host PC will be sent to the acceleration unit and the memory for queuing the commands through the interface unit. The acceleration unit is capable of determining whether the host command fits to accelerating criteria and then issues a flag signal to the microprocessor. The microprocessor executes corresponding actions, such as transmitting data to or receiving data from the host PC according to the flag signal and the ATAPI command. The buffer memory is capable of buffering the data during the communication between the device and the host PC.

The method and the system of present invention are capable of reducing the phases needed in the operation of an host command. In other words, the method and the system of present invention can minimize total duration of handling an host command. Accordingly, the transfer rate of data communication between the device and the host PC can be improved.

### BRIEF DESCRIPTION OF THE DRAWINGS

FIG. 1 illustrates a conventional operation to handle an ATAPI command.

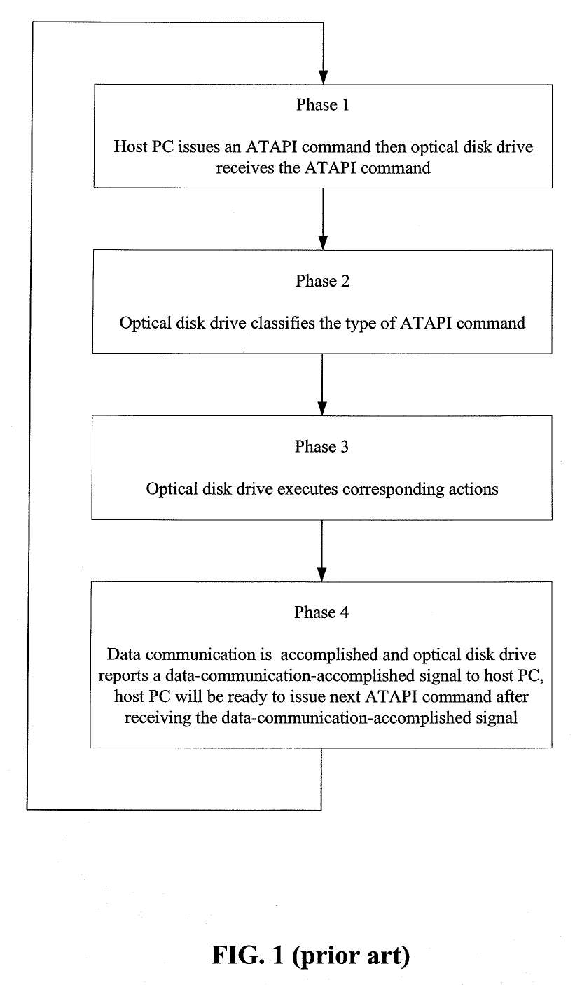

FIG. 2 illustrates a block diagram of a system including an acceleration unit of an ATAPI interface according to the present invention.

FIG. 3 illustrates a flowchart of an ATAPI interface acceleration method according to the present invention.

FIG. 4 illustrates an operational process handling an ATAPI command according to the present invention.

### DETAILED DESCRIPTION OF THE PREFERRED EMBODIMENTS

The present invention is directed to a method and a system for interface acceleration between an electronic device and a host PC. The method and the system in accordance with the present invention are capable of rapidly detecting host commands and determining the types thereof.

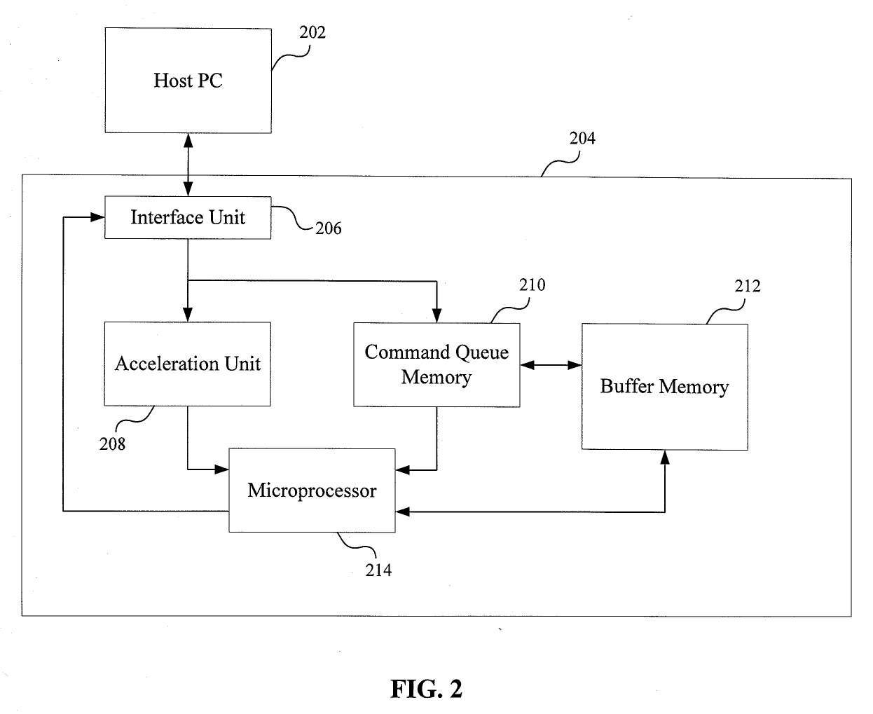

FIG. 2 illustrates a block diagram of a system 204 including an acceleration unit of an ATAPI interface according to the present invention. The system 204 comprises an interface unit 206, an acceleration unit 208, a command queue memory 210, a buffer memory 212, and a microprocessor 214. The system 204 may be provided in an optical disk drive. As shown in FIG. 2, the interface unit 206 handles data communication of an interface between the system 204 and a host PC 202. Said interface could be IDE, PATA or SATA interface etc. An host command issued from the host PC 202 is sent to the acceleration unit 208 and the command queue memory 210 through the interface unit 206. In this embodiment, the electronic device is an optical disc drive and the host command should be a ATAPI command. The acceleration unit 208 rapidly classifies the type of the ATAPI command and then issues a flag signal to the microprocessor 214 for executing corresponding actions. The command queue memory 210 is used to queue the ATAPI commands until the microprocessor 214 receives the flag signal. After the microprocessor 202 has received the flag signal, the microprocessor 214 executes corresponding actions, such as transmitting data to or receiving data from the host PC 202, according to the flag signal and the ATAPI command. The buffer memory 212 is coupled to the microprocessor 214 for buffering the data demanded by the microprocessor 214.

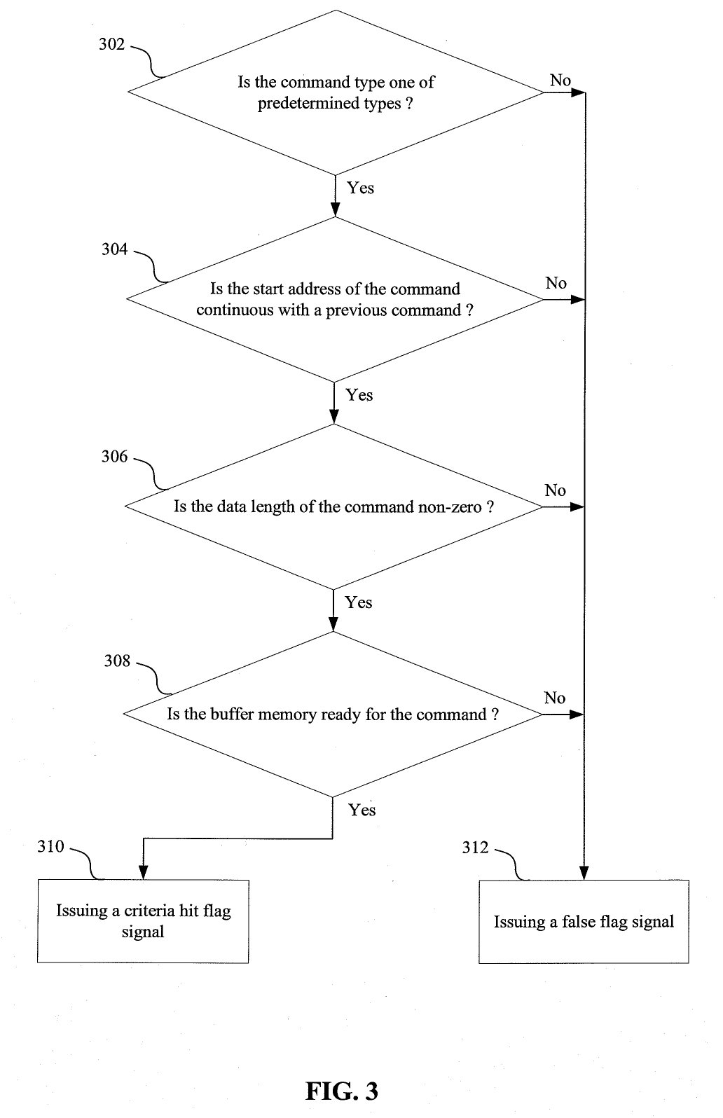

FIG. 3 illustrates a flowchart of an ATAPI interface acceleration method for accelerating an ATAPI command execution according to the present invention. The method comprises following steps of:
S302 The acceleration unit 208 determines whether the type of the ATAPI command is one of the predetermined types. The predetermined types are preset in the acceleration unit 208, such as ATAPI commands WRITE 10, WRITE 12, READ 10 and READ 12. Accordingly, it is possible to rapidly determine the corresponding actions of the microprocessor 214 without parsing the ATAPI command. The method will go to step S304 if the type of the ATAPI command belongs to one of the predetermined types, otherwise the method will go to step S312.
S304 The acceleration unit 208 determines whether a start address of the ATAPI command is continuous with an address of a previous ATAPI command. The type of the ATAPI command will be the same type of the previous ATAPI command if the start address of the ATAPI command is continuous with the address of previous ATAPI command. It is so-called “burst access”. Therefore, the acceleration unit 208 can directly report to the microprocessor 214 to execute the corresponding actions without parsing the ATAPI command by the system. The method will go to step S306 if the start address of the ATAPI command is continuous with the address of the previous ATAPI command, otherwise the method will go to step S312.
S306 The acceleration unit 208 determines whether a data length of the ATAPI command is non-zero. A zero data length of the ATAPI command means that the ATAPI command is meaningless to the microprocessor 214.

Accordingly, the microprocessor 214 will ignore the ATAPI command with zero data length. The method will go to step S308 if the data length of the ATAPI command is non-zero, otherwise the method will go to step S312.
S308 The acceleration unit 208 checks whether the buffer memory 212 is ready for the ATAPI command. If buffer memory 212 does not have enough space to store the data required by the ATAPI command or does not have the data required by the ATAPI command, the microprocessor 214 can not be allowed to execute the corresponding actions of the ATAPI command immediately for the buffer memory 212 is not ready for the ATAPI command. The ATAPI command will not be processed until the buffer memory 212 is ready for the ATAPI command. The method will go to step S310 if the buffer memory 212 is ready for the ATAPI command, otherwise the method will go to step S312.
S310 The acceleration unit 208 issues a criteria hit flag signal to the microprocessor 214 when the results of steps S302 to S308 are all true. The criteria hit flag signal means that the microprocessor 214 can immediately execute the corresponding actions of the ATAPI command without parsing the ATAPI command.
S312 The acceleration unit 208 issues a false flag signal to the micro processor 214 if any one result of steps S302 to S308 is false. The false flag signal means that the microprocessor 214 can not be allowed to directly execute the corresponding actions of the ATAPI command without parsing the ATAPI command.

According to the above description, the present invention would check at least one of the following acceleration criteria: (a). whether the command is an access command to access a storage medium;(b). whether the data to be access is continues to previous accessed data; and (c). whether a buffer memory is ready for executing the host command.

The acceleration unit 208 can be implemented by hardware or firmware in the system 204. The predetermined types of the ATAPI commands should be preset in the acceleration unit 208. The embodiments of the acceleration unit 208 can be realized by the following description of different types of the ATAPI commands.

Table 1a illustrates a command format of an ATAPI command WRITE 10. The following procedures exemplify a scheme to handle the ATAPI command WRITE 10 according to the method of present invention:

TABLE 1a

| | Bit | | | | | | | |
|---|---|---|---|---|---|---|---|---|
| Byte | 7 | 6 | 5 | 4 | 3 | 2 | 1 | 0 |

| 0 | Operation (2Ah) | | | | | |
|---|---|---|---|---|---|---|
| 1 | LUN(Obsolete) | DPO | FUA | EBP | Reserved | Reladr |

| | |
|---|---|
| 2 | (MSB) |

| 3 | Logical Block Address | |
|---|---|---|
| 4 | | |
| 5 | | (LSB) |

| 6 | Reserved | |
|---|---|---|
| 7 | (MSB) | Transfer Length |

| 8 | | | | | (LSB) |
|---|---|---|---|---|---|
| 9 | Vendor- | Reserved | NACA | Flag | Link |
| | Specific | | | | |

| | |
|---|---|
| 10 | PAD |
| 11 | |

| | |
|---|---|
| if (CmdBlk[0] == 0x2A) | (procedure 101) |
| { | |
| if (CmdBlk[2] == 0x00) | (procedure 102) |
| { | |

```
    if ((CmdBlk[3] == STADR[23:16]) && (CmdBlk[4] ==
    STADR[15:8])
```

| | |
|---|---|
| && (CmdBlk[5] == STADR[7:0])) | (procedure 103) |
| { | |
| if ( CmdBlk[7] \| CmdBlk[8]) | (procedure 104) |
| { | |
| if ( (OFST[23:16] != 0) \|\| | |

(OFST[15:8] > CmdBlk[7]) || ((OFST[15:8] ==

| | |
|---|---|
| CmdBlk[7]) && (OFST[7:0] > CmdBlk[8])) | (procedure 105) |
| { | |
| CriteriaHit = TRUE; | (procedure 106) |
| } | |
| } | |
| } | |
| } | |
| } | |

The procedure 101 is used to classify the type of the ATAPI command WRITE 10. The procedure 102 is used to check the command format of the ATAPI command WRITE 10. The procedure 103 is used to check whether the start address of the ATAPI command WRITE 10 is continuous with a command address of last command. The procedure 104 is used to check whether the data length of the ATAPI command WRITE 10 is non-zero. The procedure 105 is used to check whether the buffer memory has enough space. The procedure 106 is used to issue the criteria hit flag signal if the results of the procedure 101 to procedure 105 are all true.

Table 1b illustrates a command format of an ATAPI command WRITE 12. The following procedures exemplify a scheme to handle the ATAPI command WRITE 12 according to the method of present invention:

TABLE 1b

| | Bit | | | | | | | |
|---|---|---|---|---|---|---|---|---|
| Byte | 7 | 6 | 5 | 4 | 3 | 2 | 1 | 0 |

| 0 | Operation code (AAh) | | | | | |
|---|---|---|---|---|---|---|
| 1 | LUN(Obsolete) | DPO(0) | FUA | EBP(0) | Reserved | Reladr |

| 2 | (MSB) | |
|---|---|---|
| 3 | Logical Block Address | |
| 4 | | |
| 5 | | (LSB) |
| 6 | (MSB) | |

| 7 | Transfer Length | |
|---|---|---|
| 8 | | |
| 9 | | (LSB) |

| | | |
|---|---|---|
| 10 | Stream- | Reserved |
| | ing | |

| | | | | | |
|---|---|---|---|---|---|
| 11 | Vendor- | Reserved | NACA | Flag | Link |
| | Specific | | | | |

| if (CmdBlk[0] == 0xAA) | (procedure 201) |
|---|---|
| { | |
| if (CmdBlk[2] == 0x00) | (procedure 202) |
| { | |
| if ((CmdBlk[3] == STADR[23:16]) && (CmdBlk[4] == | |
| STADR[15:8]) | |
| && (CmdBlk[5] == STADR[7:0])) | (procedure 203) |
| { | |
| if (((CmdBlk[6] \| CmdBlk[7]) == 0) && ((CmdBlk[8] \| | |
| CmdBlk[9]) != 0)) | |
| | (procedure 204) |
| { | |
| if ( (OFST[23:16] != 0) \|\| (OFST[15:8] > | |
| CmdBlk[8]) \|\| ((OFST[15:8] == | |
| CmdBlk[7]) && (OFST[7:0] > CmdBlk[9])) | (procedure 205) |
| { | |
| CriteriaHit = TRUE; | (procedure 206) |
| } | |
| } | |
| } | |
| } | |
| } | |

The procedure 201 is used to classify the type of the ATAPI command WRITE 12. The following procedures 202 to 206 is similar to the procedures 102 to 106 aforementioned, except that the ATAPI command is WRITE 12 command. Thus the procedures 202 to 206 will not be described in detail herein.

Table 1c illustrates a command format of an ATAPI command READ 10. The following procedures exemplify a scheme to handle the ATAPI command READ 10 according the method of present invention:

TABLE 1c

| | Bit | | | | | | | |
|---|---|---|---|---|---|---|---|---|
| Byte | 7 | 6 | 5 | 4 | 3 | 2 | 1 | 0 |

| 0 | Operation (28h) | | | | |
|---|---|---|---|---|---|
| 1 | LUN(Obsolete) | DPO | FUA | Reserved | Reladr |

| | |
|---|---|
| 2 | (MSB) |

| 3 | Logical Block Address | |
|---|---|---|
| 4 | | |
| 5 | | (LSB) |

| 6 | Reserved |
|---|---|
| 7 | (MSB) |

| 8 | Transfer Length | | | | (LSB) |
|---|---|---|---|---|---|
| 9 | Vendor- | Reserved | NACA | Flag | Link |
| | Specific | | | | |

| | |
|---|---|
| 10 | PAD |
| 11 | |

| | |
|---|---|
| if (CmdBlk[0] == 0x28) | (procedure 301) |
| { | |
| if (!(CmdBlk[1] & 0x08)) | (procedure 302) |
| { | |

| | |
|---|---|
| if (CmdBlk[2] == 0x00) | (procedure 303) |
| { | |
| STADR[23:16] = CmdBlk[3]; | |
| STADR[15:8] = CmdBlk[4]; | |
| STADR[7:0] = CmdBlk[5]; | |

| | |
|---|---|
| OFST[23:0] = STADR − DEC_TLBA; | (procedure 304) |

if ((OFST[23:16] == 0) && (OFST[15:0] > 0) &&

| | |
|---|---|
| (OFST[15:0] <= DEC1_BC2)) | (procedure 305) |
| { | |
| CriteriaHit = TRUE; | (procedure 306) |
| } | |
| } | |
| } | |
| } | |

The procedure 301 is used to classify the type of the ATAPI command READ 10. The procedures 302 and 303 are used to check the command format of the ATAPI command READ 10. The procedure 304 is used to check whether the start address of the ATAPI command READ 10 is continuous with a command address of last command. The procedure 305 is used to check whether the buffer memory has the data required by the ATAPI command READ 10. The procedure 306 is used to issue the criteria hit flag signal if the results of the procedure 301 to procedure 305 are all true.

Table 1d illustrates a command format of an ATAPI command READ 12. The following procedures exemplify a scheme to handle the ATAPI command READ 12 according to the method of present invention:

TABLE 1d

| | Bit | | | | | | | |
|---|---|---|---|---|---|---|---|---|
| Byte | 7 | 6 | 5 | 4 | 3 | 2 | 1 | 0 |

| 0 | Operation code (A8h) | | | | |
|---|---|---|---|---|---|
| 1 | LUN(Obsolete) | DPO(0) | FUA | Reserved | Reladr |

| 2 | (MSB) | |
|---|---|---|
| 3 | Logical Block Address | |
| 4 | | |
| 5 | | (LSB) |
| 6 | (MSB) | |

| 7 | Transfer Length | |
|---|---|---|
| 8 | | |
| 9 | | (LSB) |

| | | |
|---|---|---|
| 10 | Streaming | Reserved |

| | | | | | |
|---|---|---|---|---|---|
| 11 | Vendor- | Reserved | NACA | Flag | Link |
| | Specific | | | | |

| | |
|---|---|
| if (CmdBlk[0] == 0xA8) | (procedure 401) |
| { | |
| if (!(CmdBlk[1] & 0x08)) | (procedure 402) |
| { | |

| | |
|---|---|
| if (CmdBlk[2] == 0x00) | (procedure 403) |
| { | |
| STADR[23:16] = CmdBlk[3]; | |
| STADR[15:8] = CmdBlk[4]; | |
| STADR[7:0] = CmdBlk[5]; | |

| | |
|---|---|
| OFST[23:0] = STADR − DEC_TLBA; | (procedure 404) |

if ((OFST[23:16] == 0) && (OFST[15:0] > 0) &&

| | |
|---|---|
| (OFST[15:0] <= DEC1_BC2)) | (procedure 405) |
| { | |
| CriteriaHit = TRUE; | (procedure 406) |
| } | |
| } | |
| } | |
| } | |

The procedure 401 is used to classify the type of the ATAPI command READ 12. The following procedures 402 to 406 is similar to the procedures 302 to 306 aforementioned, except that the ATAPI command is READ 12 command. Thus the procedures 402 to 406 will not be described in detail herein.

It should be noted that the predetermined types of the ATAPI commands can be varied according to different requirements in practice.

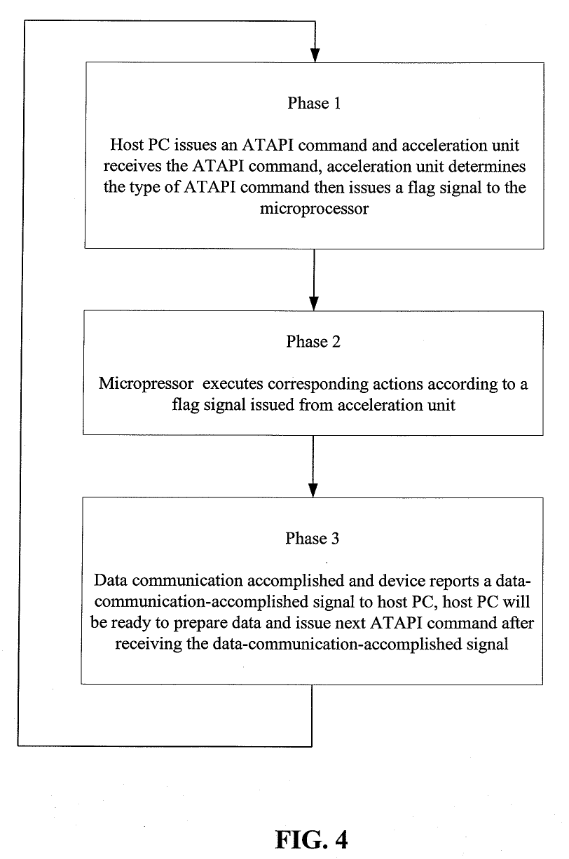

FIG. 4 shows an operation to handle an ATAPI command by the method of present invention. The operation of the method can be divided into three phases below:
Phase 1: The host PC 202 issues an ATAPI command to the acceleration unit 208. The acceleration unit 208 determines the type of the ATAPI command after the acceleration unit 208 receives the ATAPI command, and then issues a flag signal to the microprocessor 214.
Phase 2: The microprocessor 214 executes corresponding actions of the ATAPI command according to the flag signal. The corresponding actions can be data communication between the device and the host PC.
Phase 3: After the data communication of the ATAPI command is accomplished, the system reports a data-communication-accomplished signal to the host PC. The host PC 202 is ready to issue next ATAPI command after the host PC 202 has received the data-communication-accomplished signal.

In contrast with prior art, the method and the system of present invention are capable of reducing the phases needed in the operation of an ATAPI command. In other words, the method and the system of present invention can minimize total duration of processing an ATAPI command. Accordingly, the transfer rate of data communication between the device and the host PC can be improved.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A method for accelerating a host command execution, the method comprising the steps of:
determining whether the host command fits to an accelerating criteria;
generating a criteria hit flag signal if the host command fits to the accelerating criteria; and
executing corresponding actions of the host command if the criteria hit flag signal is issued.

2. The method of claim 1, wherein the accelerating criteria at least comprises:
(a). the command is an access command to access a storage medium;
(b). the data to be access is continues to previous accessed data; and
(c). a buffer memory is ready for executing the host command.

3. The method of claim 2, wherein the accelerating criteria (c) further comprises checking whether the buffer memory has enough space to store at least one portion of the data required by the host command.

4. The method of claim 2, wherein the accelerating criteria (c) further comprising checking whether the buffer memory has at least one portion of the data required by the host command.

5. The method of claim 2, wherein the accelerating criteria (b) is that a medium position of the data to be accessed corresponding to the host command is continuous to the previous accessed data.6. The method of claim 2, wherein the accelerating criteria (b) is that an address of the data to be accessed corresponding to the host command is continuous to the previous accessed data.7. The method of claim 1, further comprising the step of generating a control signal according to the content of the host command and the criteria hit flag signal, and the executing step executing the corresponding actions according to the control signal.8. The method of claim 1, further comprising the step of generating a control signal according to the content of the host command, and the executing step executing the corresponding actions according to the control signal and the criteria hit flag signal.

9. A system for accelerating an host command execution in an electronic device, the host command is issued by a host, the device comprising:
an interface unit for handling a data communication between the electronic device and the host;
an acceleration unit couple to the interface unit for receiving the host command via the interface unit, determining whether the host command fits to an accelerating criteria, and generating a criteria hit flag signal if the host command fits to the accelerating criteria; and
a microprocessor executing corresponding actions of the host command if the criteria hit flag signal is issued.

10. The system of claim 9, wherein the accelerating criteria at least comprises:
(a). the command is an access command to access a storage medium loading in the electronic device;
(b). the data to be access is continues to previous accessed data; and
(c). a buffer memory is ready for executing the host command.

11. The system of claim 10, wherein the accelerating criteria (c) further comprises checking whether the buffer memory has enough space to store at least one portion of the data required by the host command.

12. The system of claim 10, wherein the acceleration criteria (c) further comprising checking whether the buffer memory has at least one portion of the data required by the host command.

13. The system of claim 10, wherein the accelerating criteria (b) is that a medium position of the data to be accessed corresponding to the host command is continuous to the previous accessed data.

14. The system of claim 10, wherein the accelerating criteria (b) is that an address of the data to be accessed corresponding to the host command is continuous to the previous accessed data.

15. The system of claim 10, wherein the microprocessor further generates a control signal according to the content of the host command and the criteria hit flag signal, and the interface unit issuing the host to access data according to the control signal.

16. The system of claim 10, wherein the microprocessor further generates a control signal according to the content of the host command, and the interface unit issues the host to access data according to the control signal and the criteria hit flag signal from the acceleration unit.

17. The system of claim 10, further comprising a memory for storing the host command from the acceleration unit.
